(19) United States
(12) Patent Application Publication
(10) Pub. No.: US 2017/0128308 A1
(43) Pub. Date: May 11, 2017

(54) Traction Operating Table for Lower Limb Joint Surgery

(71) Applicants: National University Corp. Chiba University, Chiba-shi, Chiba (JP); Surgical Alliance Inc., Minato-ku, Tokyo (JP)

(72) Inventors: Junichi NAKAMURA, Chiba-shi, Chiba (JP); Yoshiyuki KAWASAKI, Tokyo (JP); Hajime YAMAZAKI, Tokyo (JP); Masato TANIMURA, Tokyo (JP); Morimasa YOKOTA, Tokyo (JP)

(21) Appl. No.: 15/322,639

(22) PCT Filed: Jul. 21, 2015
(86) PCT No.: PCT/JP2015/070721

§ 371 Date: Dec. 28, 2016

(30) Foreign Application Priority Data
Jul. 29, 2014 (JP) 2014-154355

(51) Int. Cl. A61H 1/02; A61G 13/00; A61G 13/02; A61H 1/00

(52) U.S. Cl. CPC A61H 1/0222; A61H 1/005; A61G 13/00; A61G 13/02

(57) ABSTRACT

[Problem] To provide a system for installing and storing a traction operating table for lower limb joint surgery, the system enabling a traction operating table for lower limb joint surgery to be more easily installed on an operating table main body.

[Solution] A traction operating table for lower limb joint surgery according to an aspect of the present invention comprises: a main frame part provided with a main frame having two rod-shaped members; a position adjusting part provided with a moving frame that is movable, and a foot fixing portion for fixing a foot; and a supporting leg part joined to the position adjusting part to support the main frame part, and capable of adjusting the incline of the main frame part. The position adjusting part includes a grip portion cap able of setting, by one gripping action, a first mode in which a moving action along the main frame and an incline adjusting action of the supporting leg part are fixed; a second mode in which the moving action along the main frame is released and the incline adjusting action of the supporting leg part is fixed; and a third mode in which the moving action along the main frame and the incline adjusting action of the supporting leg part are released.

### TECHNICAL FIELD

This invention relates to a traction operating table for lower limb joint surgery, a joint mat and a system of setting or housing system of a traction operating table for lower limb joint surgery.

### RELATED ART

A lower limb joint of a patient whose function of it is lower by deformity of cartilage or hardening causes deterioration of flexibility not only but a pain.

As a result, there is a problem that the QOL is deteriorated because of the limitation in the daily life.

For these patients, lower limb joint surgery is necessary.

Incidentally, in lower limb joint surgery, such as traction, extension, rolling internally, and turning internally or externally are necessary for keeping sufficient operating area.

As known traction surgical tables for lower limb joint surgery, in the undermentioned PATENT DOCUMENT 1-3, traction surgical tables which have a table mat and traction frame are disclosed. The table mat is set on a generic surgical table, and the traction frame is connected the surgical table. Then, the traction table can carry out traction, extension, adduction, internal rotation and external rotation of a lower limb at one time. And it can also keep or release the condition of structure at one time.

### REFERENCE FOR RELATED ART

### Patent Document

Patent Document 1: EP 1604629 A1

Patent Document 2: U.S. Pat. No. 7,316,040

Patent Document 3: US 2005/268400 A1

### SUMMARY OF THE INVENTION

### Problems to be Solved by the Invention

However, by the traction surgical table for lower limb joint surgery disclosed in the above-mentioned patent documents, both of traction and extension are carried out by one releasing operation.

Thus, though the user wants to carry out either traction or extension, he or she has to carry out both of traction and extension again.

Moreover, the safety for a patient or operator should be more improved with respect to unintentional release operation.

Thus, in consideration of the above-mentioned problem, the object of the present invention is providing a traction surgical table for lower limb joint surgery which can surely carry out traction and extension without impairing the convenience of them.

Moreover, on the other hand, the traction surgical table for lower limb joint surgery is set to a surgical main table via a joint unit.

However, since the traction surgical table for lower limb joint surgery is generally heavy, light weighting is not accomplished enough to lift up with a single hand even if the material is changed to a light metal.

Thus, it is not easy to set the traction surgical table for lower lim joint surgery to the surgical main table.

Additionally, another object of this invention is providing a setting or housing system of a traction surgical table for lower limb joint surgery which can easily set the traction surgical table for lower lib joint surgery to the surgical main table.

### Solution to the Problems

Namely, a traction surgical table for lower limb joint surgery of one aspect of the present invention has a main frame unit which has a main frame which has two parallel rod-like members, and a moving frame which can move along the main frame, a position adjustment unit which has a foot fixing unit which is set to the moving frame and fixes a foot of a patient, and a support leg unit which is connected to the position adjustment unit, supports the main frame unit and adjusts the inclination of the main frame unit.

Further, the position adjustment unit has a grip unit which can carry out, by only one grip motion, a first mode for fixing movement along the main frame and fixing adjustment of inclination of the support leg unit, a second mode for releasing movement along the main frame and fixing adjustment of inclination of the support leg unit, a third mode for releasing movement along the main frame and releasing adjustment of inclination of the support leg unit.

Moreover, the joint mat unit of another aspect of the invention has a joint mat which is set on a surgical main table, and a grid indicating member which has a transparent member which has grid lines of metal.

Moreover, a setting or housing system of a traction surgical table for lower limb joint surgery of another aspect of the invention which solves the above-mentioned problem has a traction surgical table for lower limb joint surgery and a carrier for it.

The traction surgical table for lower limb joint surgery has a main frame unit which has a main frame which has two parallel rod-like members, a position adjustment unit which has a moving frame which is movable along the main frame and a foot fixing unit which is set on the moving frame and used for fixing a foot of a patient, and a support leg unit which is connected to the position adjustment unit, supports the main frame unit and can adjust the inclination of the main frame.

The carrier has, four column frames which is arranged for keeping space for housing the traction surgical table for lower limb joint surgery and has rollers on each lower edge, a connection frame which connects the four column frames, and a frame height adjusting member which supports the main frame and adjusts the height of the main frame.

### Effect of the Invention

From the above, the present invention provides a traction surgical table for lower limb joint surgery which perform sure traction and extension without reducing the convenience of traction and extension.

Moreover, the present invention also provides a setting or housing system which easily houses the traction surgical table for lower limb joint surgery and sets it to the surgical main table.

### BRIEF DESCRIPTION OF DRAWINGS

FIG. 1 shows a schematic view of a traction surgical table for lower limb joint surgery of an embodiment of the invention.

FIG. 2 shows a schematic view of a main frame of the embodiment of the invention.

FIG. 3 shows relation of connection of a part of a surgical main body, a joint body and a main frame of the embodiment of the invention.

FIG. 4 shows relation of connection of a surgical main table, a joint unit, and a main frame, of the embodiment of the invention.

FIG. 5 shows a schematic view of setting of fixing members of the embodiment of the invention.

FIG. 6 shows an image drawing of relation of connection of a main frame and a joint unit.

FIG. 7 shows a schematic view of the structure of a grip unit of the embodiment of the invention.

FIG. 8 shows an image drawing of rotational motion of a support frame of the embodiment of the invention.

FIG. 9 shows an image drawing of rotational motion of a foot fixing frame of the embodiment of the invention.

FIG. 10 shows a schematic view of the structure of a rotation controlling unit of the embodiment of the invention.

FIG. 11 shows image drawing of a support frame position adjustment unit amount indicating unit of the embodiment of the invention.

FIG. 12 shows an image drawing of rotational motion of a support frame of the embodiment of the invention.

FIG. 13 shows a schematic view of a boot of the embodiment of the invention.

FIG. 14 shows an image drawing of a inclination indicating unit of the embodiment of the invention.

FIG. 15 shows a schematic view of a tray of the embodiment of the invention.

FIG. 16 shows an image drawing of a lower end face of a leg member a tray of the embodiment of the invention.

FIG. 17 shows a schematic view of a tray (non-surgical side) of the embodiment of the invention.

FIG. 18 shows a schematic view of a joint mat unit of the embodiment of the invention.

FIG. 19 shows an enlarged view of a joint mat unit of the embodiment of the invention.

FIG. 20 shows a schematic view of vicinity of a joint mat unit of the embodiment of the present invention.

FIG. 21 shows a schematic view of a traction surgical table for lower limb joint surgery system of the embodiment.

FIG. 22 shows a schematic view of a carrier of the embodiment of the present invention.

FIG. 23 shows a schematic view of a height adjusting member of a carrier of the embodiment of the present invention.

FIG. 24 shows an image drawing when a traction surgical table for lower limb joint surgery is jointed to a surgical main table with using a carrier of the embodiment of the invention.

### BEST MODE FOR CARRYING OUT THE PRESENT INVENTION

Hereafter, an embodiment of the present invention will be described in detail with reference to the drawings. However, the present invention will be able to be utilized by many other embodiments. So, the present invention will not be limited by the embodiment as below.

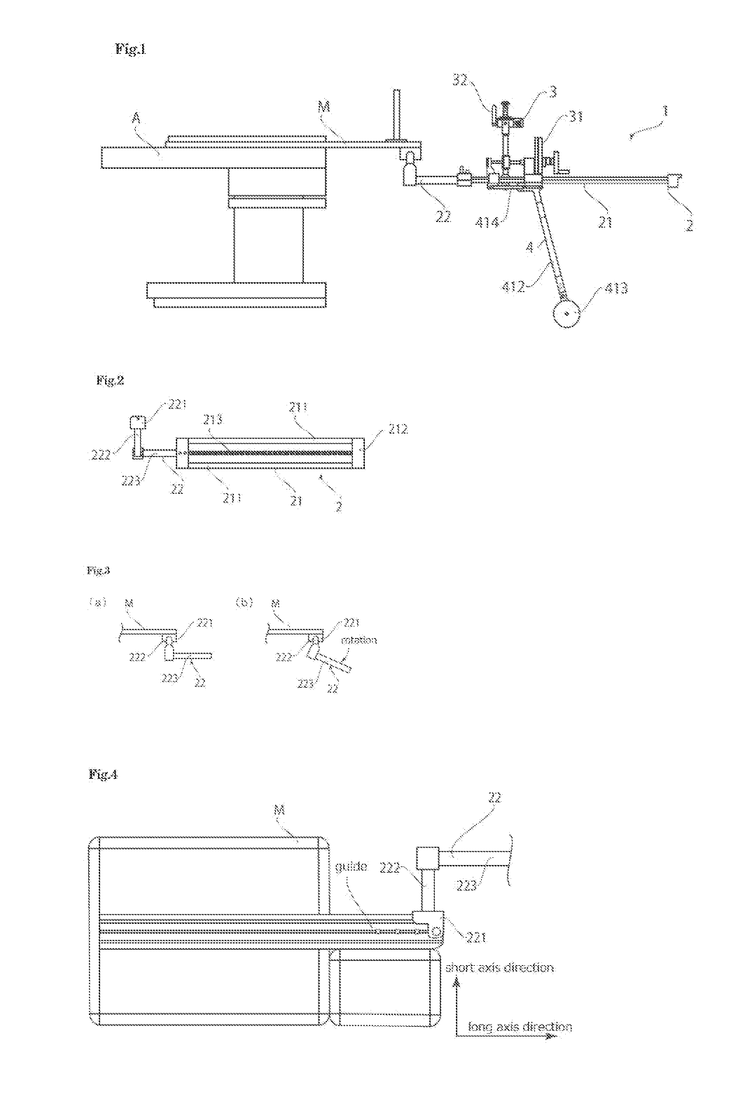

FIG. 1 shows a schematic view of a traction surgical table for lower limb joint surgery (hereafter, “the traction surgical table”) of this embodiment of the present invention.

As shown in this figure, the traction surgical table 1 comprises a main frame unit 2, and a position adjustment unit 3, a support leg unit 4.

The main frame unit 2 has a main frame 21, which has two parallel rod-like members 211.

The position adjustment unit 3 has a moving frame 31, and a foot fixing unit 32.

The moving frame 31 is movable along the main frame 21.

The foot fixing unit 32 is used for fixing the patient's foot.

The traction surgical table 1 is jointed to a surgical main table A.

An upper limb of the patient will be put down on the surgical main table A and a lower limb of the patient will be put down on the traction surgical table 1, respectively. Further the legs of the patient will be fixed on the traction surgical table.

Then, such as traction and extension is carried out to the lower limb of patient, concretely a leg, and the body position of the patient is set so as to easily operate for an operator.

The detail of operation will be clear in the description as stated below.

Moreover, a joint mat M is set on a surgical main table A, and the traction surgical table 1 is jointed to a joint mat M via a joint unit 22.

In the traction surgical table 1, the main frame unit 2 forms a basic structure of the traction surgical table 1.

The main frame unit 2 has a main frame 21 and a joint unit 22.

In the traction surgical table, the main frame unit 2 is a main part of the traction surgical table 1.

It has a main frame 21 which has two parallel rod-like members 211, and a joint unit 22 which is used for joining to a surgical main table (not shown in the figure.).

FIG. 2 shows a schematic view of the main frame unit 2.

The parallel of the two rod-like members 211 of the main frame 21 of the embodiment is realized by fixing the two rod-like members to the fixing member 212.

Incidentally, the means for fixing, it is not limited to, is carried out by inserting the rod-like member 211 into the fixing member 212, and screwing them.

Here and hereafter, the meaning of “parallel” includes ideal parallel, but it also includes substantial parallel which includes an error of a few degrees occurred in a making process.

In this embodiment, since the position adjustment unit is set to the main frame 21 and the two rod-like members 211 of the main frame supports the position adjustment unit, it is possible to make steady the position and the direction of the position adjustment unit.

Moreover, in addition to the two rod-like member 211, the main frame 21 of this embodiment has a rod-like guide member which is parallelly positioned to the two rod-like member 211.

In this embodiment, a rod-like guide member is placed between the above-mentioned two rod-like members 211, and is fixed to the above-mentioned fixing member 212.

Groove is formed around the rod-like guide member, and it is possible to be easily held by a position adjustment unit 3. The detail function of the rod-like guide member will be explained.

Moreover, as mentioned above, in this embodiment, the traction surgical table has a joint unit 22 which is jointed to the main frame 21 and the surgical main table.

FIG. 3 shows relation of connection of a part of a surgical main body, a joint body and a main frame of the embodiment of the invention.

A joint unit 22 desirably has a fixing member 221, an extension unit of a short axis 222, and a rod-like member of a long axis 223.

In this embodiment, as mentioned above, it is not limited to that as long as so as to it is possible to surely joint the main frame 21 and a surgical main table A.

The fixing member 221 is used for joining to a surgical table.

The extension unit of a short axis 222 is extended along the short axis of the surgical main table.

The extension unit of a long axis 223 is extended along the long axis of the surgical main table, and is connected to the main frame 21.

FIG. 3 and FIG. 4 show a schematic view of the fixing member 221 of the embodiment of the present invention.

As shown in these figures, a fixing member 221 is fixed, by a fixing part such as screws, on a guide which is set on lower side of the joint mat M which is set to the surgical main table A.

Incidentally, FIG. 4 shows the joint mat M without the surgical main table A. The mat which is set on non-surgical side is demountable via a groove which is engraved on lower part of the joint mat.

Incidentally, the fixing member has a knuckle shape and can reverse position by rotating 180 degrees. In some cases, it is possible to set the fixing members on both sides.

The situation is shown in FIG. 5.

Incidentally, as a result of the above-mentioned structure, the joint unit 22 is able to be set to the surgical main table as a right leg side unit or a right leg side unit, voluntarily.

As a result, it is possible to reduce the numbers of parts and to provide a traction surgical table for lower limb joint surgery with lower cost.

Moreover, in this embodiment, an extension unit of a short axis 222 is connected to a fixing member 221, and extends along the short axis from the surgical main table.

The structure of the extension unit 222 of the short axis is preferably rod-like shape, and the cross section of it is preferably a round shape, but is not limited to that.

Herewith, it is possible to connect the rod-like member 223 of the long axis to the extension unit 222 of the short axis which is a rotational center, and adjust inclination of the main frame.

Moreover, in this embodiment, as mentioned above, a rod-like member 223 of long axis side is used for connecting the main frame 21 and the surgical main table.

More concretely, the rod-like member 223 of long axis side is used for connecting a main frame 21 and an extension unit 222 of short axis side.

Moreover, in this embodiment, the rod-like member 223 of long axis side is rotatably connected to the extension unit 222 of short axis side.

As a result, as mentioned above, it is possible to adjust the inclination of the main frame.

Moreover, in this embodiment, the main frame 21 and the joint unit 22 may be fixed or detachable.

For realize that, it is desirable that the fixing member 212 of the main frame 21 has a hole for inserting the rod-like member 223 of a long axis, and a pin is inserted into a small hole for transfix the rod-like member 223 and a fix member after inserting the rod-like member 223 into the hole.

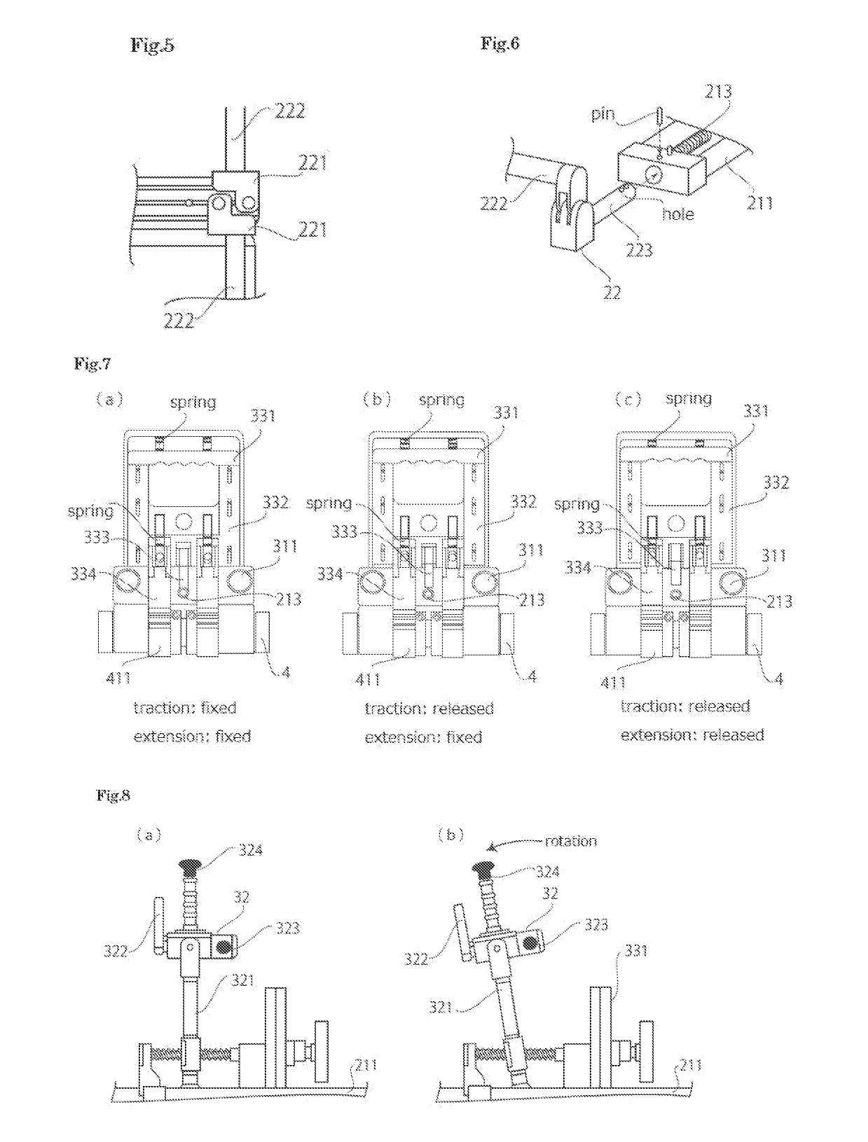

FIG. 6 shows an image drawing of an example.

Moreover, the position adjustment unit 3 is used for easily carrying out a surgery by fixing the foot of the patient and adjusting the position of it.

The position adjustment unit 3 of this embodiment has a moving frame 31 and a foot fixing unit 32. The moving frame 31 is movable along the main frame 21. Further, the foot fixing unit 32 is set on the moving frame 31, and is used for fixing the foot of the patient.

In this embodiment, as mentioned above, the moving frame 31 is used for moving the whole position adjustment unit 3 along the main frame 21, and for housing or keeping the parts which are consisting of position adjustment unit 3.

It is desirable that the moving frame 31 has an open hole 311 for inserting two rod-like member 211, but is not limited to that.

By that, it is possible to slide the position adjustment unit on the rod-like member.

Moreover, in this embodiment, the position adjustment unit 3 has a grip unit 33 which can carry out the first mode, the second mode and the third mode by grip motion only.

In the first mode, movement along the main frame and adjustment of the inclination of the support leg unit are both fixed.

In the second mode, movement along the main frame is released and adjustment of the inclination of the support leg unit is fixed.

In the third mode, movement along the main frame and adjustment of the inclination of the support leg unit are both released.

As mentioned above, by the known technology, since both of traction and extension are carried out at same time, it is necessary to reset the condition of traction and extension even if the user wanted to carry out only either of traction or extension.

Moreover, there remains a problem for safety for a patient and an operator by unintentional releasing operation.

On the other hand, by the structure, the traction surgical table for lower limb joint surgery can surely carry out traction and extension without impairing the convenience of traction and extension.

In this embodiment, the grip unit 33 has a grip 331, a transmission member 332, a first holding unit 333, and a second holding unit 334.

The transmission member 332 is used for transmitting the amount of the gripping of the grip 33.

The first holding unit 333 and the second holding unit 334 are movable up and down according to the amount of movement of the transmission member 332, respectively.

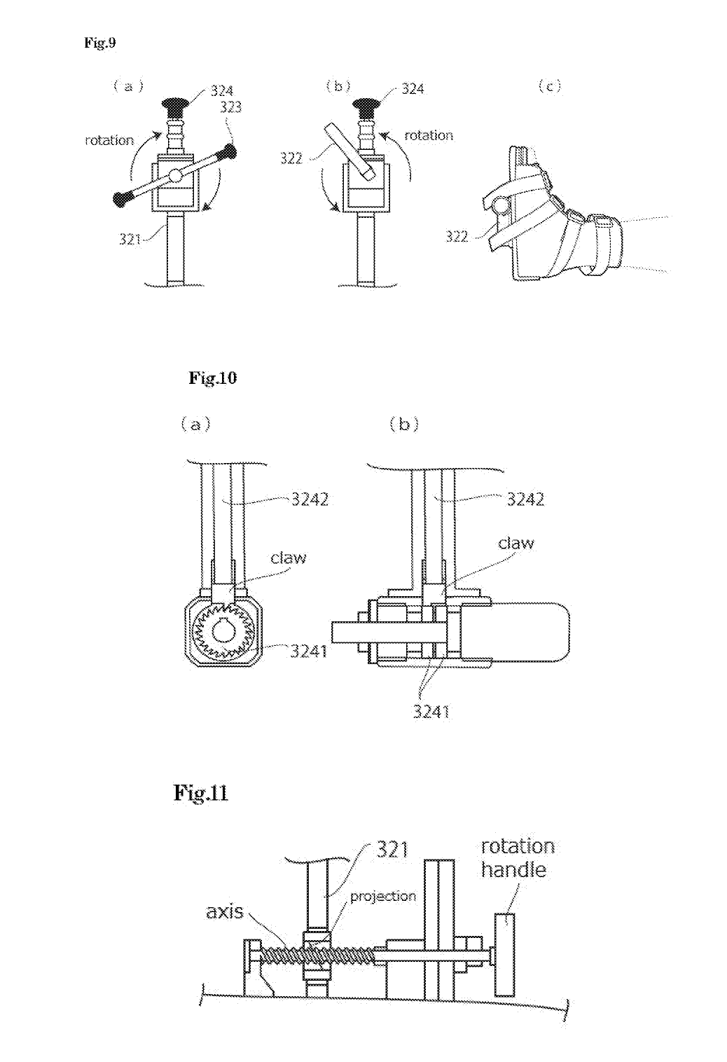

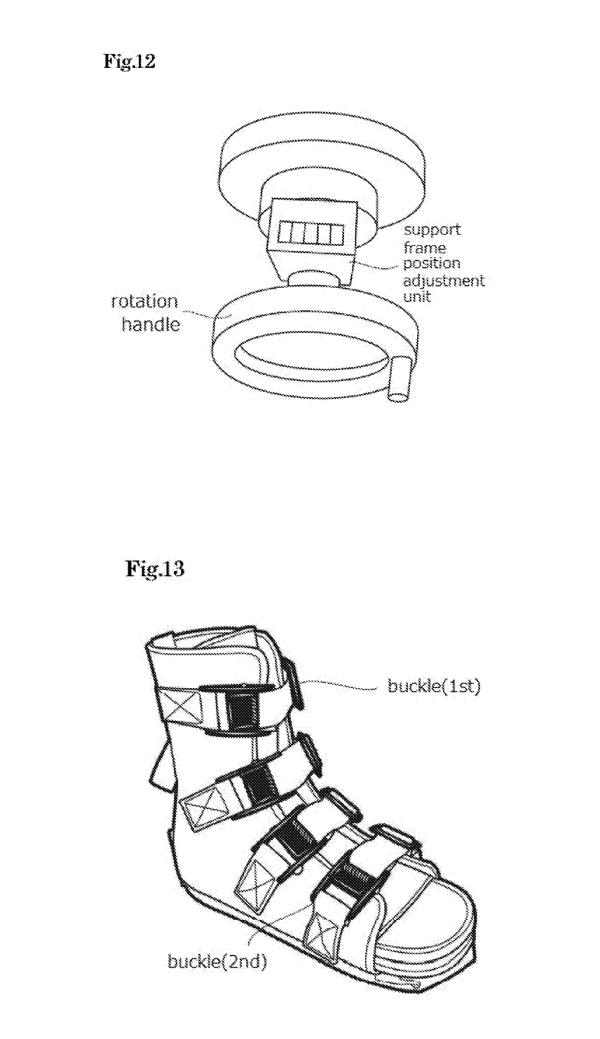

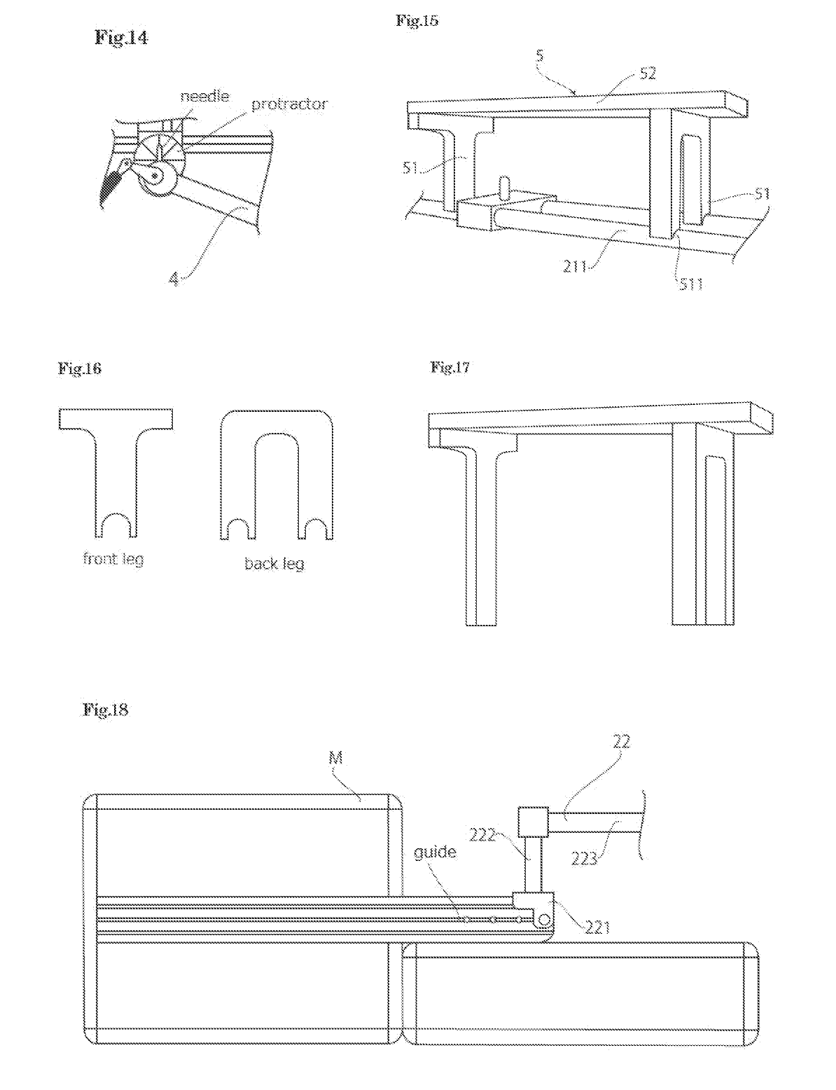

FIGS. 7(a),(b), and (c) show schematic views of the structure of the grip unit, respectively.

In this embodiment, a grip 331 is gripped by the person who wanted to adjust the inclination of the traction surgical table (hereafter referred to as “user”).

The grip 331 has an energizing means such as a spring. So, it is possible to push into the housing when gripped vigorously, and the position backs to the original position when the tension is released.

As mentioned above, the transmission member 332 is a member which can transmit the amount of grip of the grip 331.

Moreover, in this embodiment, the position of first holding unit 333 and the position of the second holding unit 334 are changed based on the amount of grip of the grip 331, and it is possible to control fixing or releasing of object to hold.

In this embodiment, the first holding unit 333 is used for movement of the position adjustment unit 3. More concretely, the first holding unit 333 is used for fixing or releasing of the movement along the rod-like member 211 of the main frame 21.

Further concretely, when the grip is not gripped, the first holding unit 333 is engaged to the groove of the rod-like member of the main frame unit 2, and the position is fixed (the first mode).

On the other hand, when the grip is softly gripped, the holding unit is lifted up from the groove by the transmission member, it is possible to move along the extended direction of the rod-like member of the main frame 21 of the position adjustment unit 3.

However, since the needed amount of gripping for movement of the first holding unit is different from that of the second holding unit, the second holding unit 334 can fix the object for fixing (the axis 411 which has the groove) in the case that the grip is softly gripped (the second mode).

In this embodiment, the second holding unit 334 is used for fixing or releasing the inclination of the main frame unit 2.

More concretely, it is possible to fix or adjust the inclination by fixing or releasing the support leg unit 4.

Further concretely, the second holding unit is engaged the groove 411 of a support leg unit 4, is used for fixing or releasing the movement of the support leg unit, and can move up and down based on the movement of the transmission member 332.

Especially, the second holding unit 334 is held to the transmission member 332 via an energizing means such as a spring, can fix the support leg unit 4 for the prescribed length even if after going up of the first holding unit, and can release the axis 411 which is engaged the groove when the grip is gripped.

Moreover, in this embodiment, the foot fixing unit 32 is arranged in the position adjustment unit 3.

The foot fixing unit 32 is used for fixing a foot of a patient.

The foot fixing unit has a foot support frame 321 which is connected to the moving frame 31, a foot fixing frame 322 which is supported by the foot support frame 321 and fixes a foot of a patient, a rotation handle 323 which rotates the foot fixing frame 322, and a rotation direction control unit 324 which controls the rotation direction of the rotation handle, but is not limited to that so far as it can has the above-mentioned function.

In this embodiment, as mentioned above, the foot support frame 321 is used for supporting the foot fixing frame 322, and it is connected the moving frame 31.

Incidentally, as mentioned below, it is possible to adjust the position of the foot support frame 321, and the foot support frame 321 can rotate on an axis on a point of the moving frame.

The image drawing is shown in FIG. 8.

Moreover, in this embodiment, the foot fixing frame 322 is used for fixing the foot of the patient. As mentioned below, the foot fixing frame can be inserted into an inserting member of the boot and fixed the foot of the patient with the whole boot.

Incidentally, the foot fixing frame is rotatably connected to the support frame 321 via an axis. Further, it is possible to rotate to another direction by a rotation handle.

The image drawing is shown in FIG. 9.

Moreover, in this embodiment, as mentioned the above figure, the rotation handle 323 is used for rotating the foot fixing frame 322.

For making the structure simple, it is desirable that the rotation handle 323 is connected to the foot fixing frame.

Incidentally, in this embodiment, the rod-like member is a handle but a stick is also usable.

Incidentally, in this embodiment, the rotation direction control unit 324 is used for controlling the rotation direction of the rotation handle.

The rotation direction control unit 324 desirably has a pair of gears 3241 which are arranged in parallel on which the graving direction of the grooves are opposite, and a rod-like member 3242 which has a nail which can be rotated and be engaged to either of the gears.

But the structure of it is not limited to that.

The schematic drawing is shown in FIG. 10.

By this, it is possible to control the rotation direction, and restrict the rotation direction of the foot of the patient.

As a result, it is possible to realize the stable locking.

Further, in this embodiment, the foot fixing unit has a support frame position adjustment unit which adjusts the position of a foot support frame, and a support frame position amount indicating unit which indicates the amount of the position adjustment of the support frame.

The image was shown in FIG. 11.

In this embodiment, the support frame position adjustment unit is used for adjusting the position of the foot support frame.

It is desirable that the support frame position adjustment unit which has an axis member which has a thread groove and is connected to a moving frame, and a rotation handle which is used for rotating the axis member, but is not limited to that.

Incidentally, in this case, the axis member pierces the foot support frame, and has a projection which is fitted to the thread groove of the above-mentioned foot support frame.

Thus, by engaging the projection and the thread groove, and rotating by rotating the handle, it is possible to move the support frame according to the rotation.

As mentioned above, a support frame position adjustment amount indicating unit of the frame is used for measuring and indicating the amount of the position adjustment of the support frame position adjustment unit.

It is desirable that the support frame position adjustment amount indicating unit has a counter which measures and indicates the amount of rotation of the rotation handle, but is not limited to that.

FIG. 12 shows an example of the unit.

Moreover, in this embodiment, the boot has a bottom unit which has an insert unit for inserting a foot fixing frame on the back surface of the boot, a side unit which covers the both sides of the foot of the patient, and buckles and belts which fixe the both side units.

The buckle has the structure which can hold the belt double

FIG. 13 shows a schematic view of the boot.

As shown in this figure, since a bootlace member is doubly fastened at one side, it is possible to fix the foot of the patient stably.

Moreover, in this embodiment, it is desirable that the main frame 21 has a frame inclining angle indicating unit 213 which indicates the inclining angle of the main frame 21.

By the unit, it is possible to confirm how much the main frame is inclined, and prevent inclining a leg of a patient more than necessary.

Incidentally, it is desirable that the inclination indicating unit has an angle sensor which detects the inclining angle, and a display device on the main frame.

It is also desirable that the inclination indicating unit has a protractor which indicates the angle and can rotates around a center point, a needle member which is used with the protractor.

The setting of the traction surgical table is different depending on the height of the surgical main table A. In the situation, the amount of adjustment of the support leg unit 4 is also different.

Thereat, by rotating the protractor and adjusting so that the amount of the adjustment of the support leg unit 4 is zero in the condition which the main frame is parallel to the floor, it is possible to measure the amount of moving the support leg unit 4 as an angle.

FIG. 14 shows an image drawing of the case.

Moreover, as mentioned above, in the traction surgical table 1, the support leg unit 4 is jointed to the position adjustment unit 3 and supports the main frame 2. Further the support leg 4 is used for adjusting the inclination of the main frame unit 2.

It is desirable that the support leg unit 4 has an axis member 411 which is supported to a moving frame 31, a rod-like member 412 which is connected to the axis member 411 and rotatable against to the moving frame 31, a roller 413 which is connected to the lower edge of the rod-like member 412, and a loading member 414 which applies load against the rotation of the rod-like member.

In this embodiment, the axis member 411 is supported the moving frame 31. And, as mentioned above, Releasing and locking of the rotation is controllable by controlling the grip unit (see FIG. 7).

In the case that the rotation is locked, it is impossible to rotate. Then the rod-like member cannot also rotate.

As a result, since the rod-like member is not movable, it is possible to keep the inclination as a constant.

On the other hand, since the axis member can rotate freely when the rotation is released, it is possible to freely control the inclination of the main frame.

Moreover, since a groove is formed around the axis member 411, it is possible to lock the rotation angle if the above-mentioned second holding unit is engaged the groove, and it is possible to adjust the rotation angle if the second holding unit is removed.

In this embodiment, as mentioned above, a rod-like member is jointed to the axis member 411, and rotates according to the amount of the rotation of the axis member.

It is desirable that there are two rod-like members and the main frame is arranged between the two rod-like members.

By the structure, it is possible to keep the main frame stably.

Moreover, in this embodiment, a roller 413 is arranged on the lower edge of the rod-like member so as to move smoothly on the setting face.

Incidentally, in this embodiment, for stably movement, it is desirable that the roller 413 is fixed by an axis member that pierce the above-mentioned two rod-like member, but is not limited to that.

Moreover, in this embodiment, as mentioned above, the load 441 is used for placing a load against a rotation of the rod-like member.

By this load 411, it is possible to avoid an unintentional accident by suddenly rotation, such as a sudden load to a patient.

Moreover, a tray 5 is set on the traction surgical table 1.

The traction surgical table is used for traction and extension of the lower limb of the patient.

However, wide open space is formed under the lower limb of the patient. Thus, it is necessary to support the leg of the patient by another means before fixing the leg to the traction surgical table.

On the other hand, since the traction surgical table has a tray, it is possible to surely support the lower limb of the patient, in, before or after a surgery.

And then, a tray 5 of this embodiment has at least three leg members 51 and a mat unit 52.

The lower end faces of the three leg members 51 are formed to fit the form of the rod-like member 223 of the joint unit or two rod-like member 211 of the main frame 21, respectively.

The mat unit 52 is set on the three leg members.

FIG. 15 shows a schematic view of a tray of this embodiment.

In this embodiment, a leg member 51 is set on the rod-like member 223 of the joint unit 22 and two rod-like member 211 of the main frame 21. Further, the leg member 51 supports the mat unit 52.

It will be possible to stably support the lower limb of the patient by at least three leg members.

Moreover, in this embodiment, it is desirable that the lower end face of the leg member 51 is formed to fit the cross-sectional form of the joint unit rod-like member 223 and two rod-like members of the main frame 21.

Concretely, it is desirable that the lower end face is corresponded to the form of the upper half of the cross-section of the rod-like member, more concretely, semicircle.

FIG. 16 shows an image drawing of the lower end face.

Moreover, in this embodiment, it is desirable that the traction surgical table 1 has a tray which is set on the non-surgical side, but is not limited to that.

It is desirable that the length of the mat of the tray of non-surgical side is the length enough to support a buttocks of a patient. But, for some types of surgical tables, it is more desirable that the length is the length enough to support a whole lower limb.

FIG. 17 shows the example.

The leg member of the tray is extended to floor and the end face of the leg member is flat, which is unlike the tray of surgical side.

Incidentally, instead of setting a tray on non-surgical side, it is desirable that the length of the mat part, which supports the buttocks of the patient, may be longed enough to support the lower limb whole of the patient.

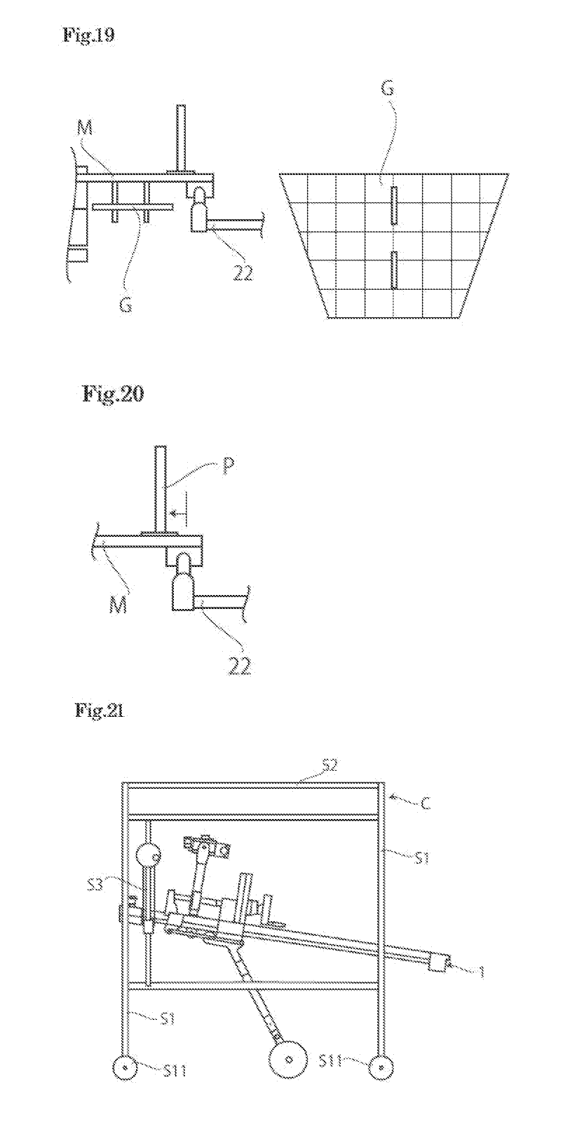

FIG. 18 shows an example of the case.

Moreover, in this embodiment, a grid indicating member G is set under the joint mat M. The grid indicating member G has a transparent member and metal grid line.

FIG. 19 shows the schematic view.

According to this embodiment, by setting the grid indicating member under the joint mat M and emitting the radiation from upper side, it is possible to display a part of the body of the patient and the grid line. Thus, it is possible to easily adjust the position of surgery area.

Further, the joint mat M of this embodiment has a pole P for fixing a hip joint of a patient on the upper side of the joint mat, a connection and fixing member of a joint unit 2 on the lower side of the joint mat.

However, the position of the pole P and the position of the connection and fixing member is not same. The connection and fixing member is nearer the main frame unit than the pole P.

By this, it is possible to secure a distance from the traction surgical table to a body of a patient on a long axis side of the surgical main table.

Further, it is possible to cut off X-ray by avoiding overlapping the joint mat and the imaging part of the patient.

FIG. 20 shows the schematic view.

Incidentally, a joint mat unit includes a joint mat M and a pole P.

From the above, by the present invention, it is possible to provide a traction surgical table for lower limb joint surgery which surely carries out traction and extension, without losing the convenience of traction and extension.

(A Traction Surgical Table for Lower Limb Joint Surgery which has a Carrier)

Incidentally, the traction surgical table and attachments are housed in a carrier, and they will be a traction surgical table system for lower limb joint surgery (hereafter “the system”).

The detail will be described as below.

As mentioned above, the traction surgical table for lower limb joint surgery is jointed to the surgical main table via the joint unit.

However, since the traction surgical table for lower limb joint surgery is generally heavy, it is difficult to be light enough to lift up the traction surgical table by single hand even if the light metal is adopted, now.

It is not easy to set a traction surgical table for lower limb joint surgery to a surgical main table.

Thus, it is not easy to set a traction surgical table for lower limb joint surgery to a surgical main table.

Then, the system S has the above-mentioned traction surgical table 1 and a carrier C.

Concretely, the traction surgical table 1 has a main frame unit which has a main frame which has two parallel rod-like members, a moving frame which is movable along the main frame, a position adjustment unit which is set on the moving frame and fixes a foot of a patient, and a support leg unit which is connected to the position adjustment unit, supports the main frame unit and adjusts the inclination of the main frame unit.

The carrier C has four column frames S1 for keeping space for housing the traction surgical table for lower limb joint surgery, a connection frame S2 which connects the four column frames, a frame height adjusting member S3 which supports the main frame and adjusts the height of it.

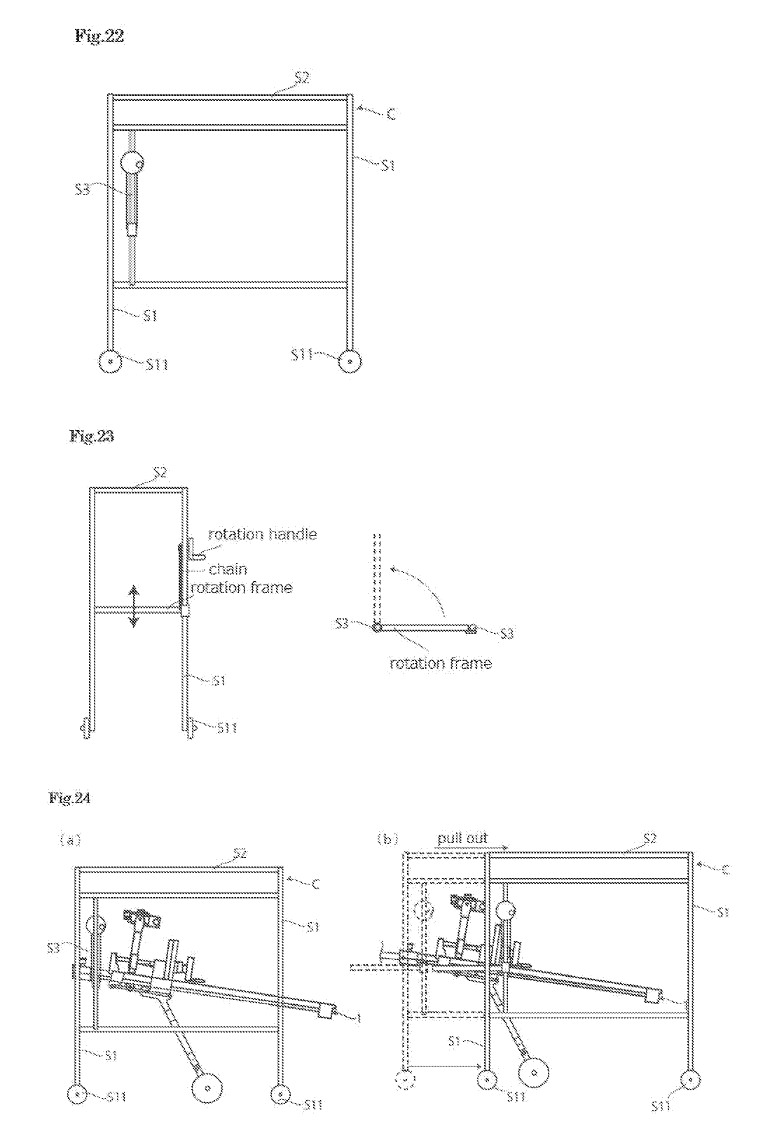

FIG. 21 shows the schematic view of the system S, and FIG. 22 shows the schematic view of the carrier C, respectively.

It is desirable that the traction surgical table for lower limb joint surgery 1 of this system basically has the structure of the embodiment mentioned above, but is not limited to that so far as it has a main frame unit and a connection member for connecting to the surgical main table.

Moreover, the carrier C of this embodiment (hereafter referred to as “the carrier C”) has four column frames S1 which has rollers S11 on the lower edges, a connection frame S2 which connects the four column frames on the upper edges of them, a frame height adjusting member S3 which supports the mainframe and adjusts the height of the main frame.

As mentioned above, the structure of the carrier C is not limited to that as far as it is possible to keep space for housing the traction surgical table for lower limb joint surgery.

In this embodiment, as mentioned above, the number of column, size, and material of the column frame S1 is appropriately adjustable as far as it is possible to keep space wide enough to house the traction surgical table for lower limb joint surgery.

Moreover, as mentioned above, rollers S11 are attached to the lower edge of the column frame S1. By them, it is possible to move with the traction surgical table for lower limb joint surgery, and adjust the position in plane surface with respect to the surgical main table.

Moreover, the carrier C has a connection frame S2 which connects four column frames.

The material and the size of it are adjustable appropriately in so far as it is possible to keep space for housing the traction surgical table for lower limb joint surgery.

However, in this case, it is desirable that the connection frame is connected to the top part of the four column frames, for dividing the carrier C and the traction surgical table without requesting a special motion such as lifting a carrier C.

Moreover, in this embodiment, the system has a frame height adjusting member S3 which supports the main frame of the traction surgical table for lower limb joint surgery and adjusts the height of the main frame.

The schematic view of the frame height adjusting member is shown in FIG. 23.

The frame height adjusting member is used for adjusting the height of the main frame, supporting the main frame only using the carrier C, and connecting and fixing the traction surgical table for lower limb joint surgery to the surgical main table via the joint unit 22.

By the member, it is possible to set the traction surgical table for lower limb joint surgery very easily.

More concretely, it is desirable that the height support member has a rotation frame which is rotatable on a surface which is perpendicular to a carrier setting surface and a lifting unit which lifts the rotation frame.

It is desirable that the lifting unit has a chain which lifts the rotation frame by rotation of a rotation handle, but is not limited to that.

As a result, in the embodiment, a user sets the traction surgical table to the inner space of the carrier C, and make the main frame unit supported to the rotational frame of the height support unit.

As a result, it is possible to carry the traction surgical table and a carrier C, simultaneously.

In this case, since the traction surgical table is supported by the carrier C, it is not necessary to lift the traction surgical table.

And then, after bringing near the surgical main table to be set, and adjusting the height and horizontal position of the main frame unit by using the frame height adjusting member S3, the traction surgical table is jointed to the surgical main table.

And then, after setting the traction surgical table for lower limb joint surgery, rotating forward the rotating frame and pulling the carrier C, it is possible to be remain only the traction surgical table for lower limb joint surgery and surgical main table.

FIG. 24 shows an image drawing of that.

On the other hand, it is possible to easily remove the traction surgical table for lower limb joint surgery from the surgical main table by reverse procedure.

Moreover, in this embodiment, it is desirable that the carrier C has a joint unit housing unit which houses the joint unit 22.

By the joint unit housing unit, it is possible to house all necessary parts in the carrier C, and to keep the traction surgical table for lower limb joint surgery safely.

As above mentioned structure, traction surgical table system for lower limb joint surgery, by which the traction surgical table for lower limb joint surgery is able to be joint to the surgical main table, is provided.

### INDUSTRIAL APPLICABILITY

The present invention is industrially applicable for a traction surgical table for lower limb joint surgery and a traction surgical table for lower limb joint surgery system.

What is claimed is:

1. A traction surgical table for lower limb joint surgery comprising:
a main frame unit having a mainframe having two rod-like member which are arranged parallel;
a position adjustment unit having a moving frame and a foot fixing unit; and
a support leg unit which is connected to said position adjustment unit and supports said main frame unit,
wherein
said moving frame is movable along said main frame,
said foot fixing unit fixes a foot of a patient,
said support leg is adjustable the inclination of said main frame unit, and
said position adjustment unit has a grip unit which can carry out, by only one grip motion, a first mode for fixing movement along the main frame and fixing adjustment of inclination of said support leg unit, a second mode for releasing movement along said main frame and fixing adjustment of inclination of said support leg unit, a third mode for releasing movement along said main frame and releasing adjustment of inclination of said support leg unit.

2. The traction surgical table for lower limb joint surgery according to claim 1, wherein
said foot fixing unit has a foot support frame which is connected to said moving frame, a foot fixing frame which is supported by said foot support frame and is used for fixing said foot of said patient,
a rotation handle which is used for rotating said foot fixing frame, and
a rotation direction control unit which control the rotation direction of said rotation handle.

3. The traction surgical table for lower limb joint surgery according to claim 1, wherein
said main frame unit has a joint unit which is connected to a surgical main table, and
said joint unit has
a fixing member which is connected to a joint mat which is set on said surgical main table,
an extension unit of short axis which is extended along the short axis of said surgical main table from said fixing member, and
a rod-like member of long axis which is connected said extension unit of short axis, is extended along the direction of said long axis of said surgical main table, and is connectable to said main frame.

4. The traction surgical table for lower limb joint surgery according to claim 3, wherein
said joint unit is both settable as for the right foot and left foot against said joint mat which is set on said surgical main table.

5. The traction surgical table for lower limb joint surgery according to claim 2, wherein
said foot fixing unit has
a foot support frame position adjustment unit which adjusts the position of said foot support frame, and
a support frame position adjustment amount indicating unit which indicates the position adjustment unit of said foot support frame.

6. The traction surgical table for lower limb joint surgery according to claim 1, further comprising a frame inclining angle indicating unit which indicates a inclining angle of said main frame.

7. The traction surgical table for lower limb joint surgery according to claim 1, further comprising a boot which has
a bottom unit which has an insert unit for inserting a foot fixing frame on a back surface,
a side unit which covers the both sides of said foot of said patient, and
buckles and belts which fix both of said side units,
wherein said buckle has the structure which can hold the belt double.

8. The traction surgical table for lower limb joint surgery according to claim 3, further comprising a tray unit which has
three leg members whose lower end surface is formed to be matched to either said rod-like member of long axis or two rod-like member of said main frame, and
a mat member which is set on said three leg members.
